(19) United States
(12) Patent Application Publication
(10) Pub. No.: US 2025/0354025 A1
(43) Pub. Date: Nov. 20, 2025

(54) INK COMPOSITIONS SUBSTANTIALLY FREE OF LOW-BOILING ORGANIC SOLVENTS AND METHODS FOR PRODUCING THE SAME

(71) Applicant: Xerox Corporation, Norwalk, CT (US)

(72) Inventors: Genggeng QI, Webster, NY (US); Chieh-Min CHENG, Rochester, NY (US)

(73) Assignee: Xerox Corporation, Norwalk, CT (US)

(21) Appl. No.: 18/668,360

(22) Filed: May 20, 2024

(51) Int. Cl. C09D 11/10; C09D 11/037

(52) U.S. Cl. CPC C09D 11/10; C09D 11/037

(57) ABSTRACT

Ink compositions may be prepared by obtaining a polymer dispersion in a high-boiling organic solvent having a boiling point of about 145° C. to about 400° C., combining the polymer dispersion with an aqueous carrier fluid without removing at least a portion of the high-boiling organic solvent to form a continuous phase, and combining one or more colorants and, optionally, one or more additives with the continuous phase to form an ink composition comprising the one or more colorants dispersed as solids in the continuous phase. The polymer dispersions and the ink compositions contain about 10 wt % or less organic solvents having a boiling point of about 140° C. or less, and may be substantially free of such organic solvents.

### FIELD

The present disclosure generally relates to printing, and more specifically, formulation of ink compositions containing a polymeric dispersant.

### BACKGROUND

Ink compositions include various colorants, including pigments, to impart coloration thereto. In order for the ink composition to provide reliable printing and coloration performance, pigment(s) need to be adequately and reliably dispersed in the ink. Poorly dispersed pigment(s) may lead to storage instability, clogging of printing nozzles, poor optical density and/or inconsistent coloration, and/or loss of covering power.

Polymeric dispersants may be utilized to promote dispersion of pigment(s) in ink compositions, especially those containing an aqueous carrier fluid (e.g., water-based ink compositions). Such dispersants are usually synthesized via a three-step solution polymerization process: 1) monomer polymerization in a low-boiling organic solvent (boiling point less than about 140° C.), 2) solvent removal to recover the polymeric dispersant, either as a melt or as a concentrate, and 3) redissolution of the polymeric dispersant in an aqueous carrier fluid suitable for forming an ink composition. The aqueous carrier fluid may comprise water and other additives, including a neutralizer and water-soluble organic solvents differing from the low-boiling organic solvent used for polymerization to promote dissolution of the polymeric dispersant in the aqueous carrier fluid and to improve pigment wetting. Common low-boiling organic solvents for conducting solution polymerization may include isopropanol, methyl ethyl ketone, methyl isobutyl ketone, butanol, butyl acetate, toluene, xylenes, and propylene glycol monomethyl ether, for example.

Polymeric dispersants may provide benefits such as, for example, greater ink stability, improved jetting performance, and an overall improvement in print quality. Unfortunately, the low-boiling organic solvents utilized in forming polymeric dispersants may be problematic in various respects. Removal of low-boiling organic solvents from the polymeric dispersant may be time-consuming, energy-intensive, and costly due to capital equipment expenditures and generation of solvent waste. Moreover, if not effectively removed, trace amounts of low-boiling organic solvents may be introduced to an ink composition. The presence of even trace amounts of low-boiling organic solvents may be undesirable due to release of volatile organic compounds (VOCs) during printing and their adverse influence on printing quality.

### SUMMARY

In some embodiments, the present disclosure provides ink compositions comprising: a continuous phase comprising water and one or more high-boiling organic solvents having a boiling point of about 145° C. to about 400° C., a polymeric dispersant dispersed as solids or dissolved in the continuous phase, and one or more colorants dispersed as solids in the continuous phase. The continuous phase contains about 10 wt % or less organic solvents having a boiling point of about 140° C. or less.

In some or other embodiments, the present disclosure provides polymer dispersions suitable for forming an ink composition. The polymer dispersions comprise: one or more high-boiling organic solvents having a boiling point of about 145° C. to about 400° C., and a polymeric dispersant dissolved or dispersed as solids in the one or more high-boiling organic solvents. The polymer dispersions contain about 10 wt % or less organic solvents having a boiling point of about 140° C. or less.

In still other embodiments, the present disclosure provides methods for forming an ink composition. The methods comprise: obtaining a polymer dispersion comprising a polymeric dispersant that is dissolved or dispersed as solids in one or more high-boiling organic solvents having a boiling point of about 145° C. to about 400° C.; wherein the polymer dispersion contains about 10 wt % or less organic solvents having a boiling point of about 140° C. or less; combining the polymer dispersion with an aqueous carrier fluid without removing at least a portion of the high-boiling organic solvent to form a continuous phase; wherein the polymeric dispersant is dissolved or dispersed as solids in the continuous phase; and combining one or more colorants and, optionally, one or more additives with the continuous phase containing the polymeric dispersant to form an ink composition comprising the one or more colorants dispersed as solids in the continuous phase.

### BRIEF DESCRIPTION OF THE DRAWINGS

Not applicable.

### DETAILED DESCRIPTION

The present disclosure generally relates to printing, and more specifically, formulation of ink compositions containing a polymeric dispersant.

As discussed above, polymeric dispersants may be utilized for promoting dispersion of pigments and other colorants in ink compositions. However, the low-boiling organic solvents commonly used in forming polymeric dispersants may be problematic. Time-consuming, energy-intensive, and costly processes may be needed to remove low-boiling organic solvents from a polymeric dispersant prior to forming an ink composition; otherwise trace organic solvents may be introduced to the ink composition and present additional operability issues.

The present disclosure provides procedures that may overcome one or more of the foregoing issues. Namely, the present disclosure demonstrates that polymeric dispersants may be effectively synthesized in high-boiling organic solvents (e.g., protic solvents such as, for instance monoprotic alcohols, glycols or polyols, or glycol or polyol monoethers or monoesters, or aprotic solvents such as, for instance, substituted amides, dimethylsulfoxide, or tetramethylenesulfone) having a boiling point of about 145° C. or above (e.g., about 145° C. to about 400° C., or about 150° C. to about 300° C., or about 150° C. to about 250° C.). Surprisingly, the properties of the resulting polymeric dispersant may be equivalent or similar to those produced when using a low-boiling organic solvent to conduct the polymerization reaction. Further, by adjusting one or more reaction conditions in the presence of the high-boiling organic solvent, the properties of the polymeric dispersant may be altered to address various application-specific needs, which may be encountered in various custom printing processes.

Even with the surprising result that high-boiling organic solvents may be effectively used to form polymeric dispersants, the foregoing finding is rather counterintuitive with respect to forming an ink composition. Namely, since high-boiling organic solvents are more difficult to remove from the polymeric dispersant by virtue of their high boiling points, they would be expected to increase the difficulty of adjusting the solvent content of an ink composition. Although high-boiling organic solvents are not easily removed from a polymeric dispersant following synthesis, this is of no significant consequence in the present disclosure, as explained subsequently.

Namely, certain high-boiling organic solvents, such as monoprotic alcohols, glycols or polyols, or glycol or polyol monoethers or monoesters, are commonly utilized in small amounts when formulating ink compositions containing conventionally synthesized polymeric dispersants (e.g., polymeric dispersants produced in the presence of a low-boiling organic solvent). The high-boiling organic solvent may promote dissolution of the polymeric dispersant in an aqueous carrier fluid (e.g., water or an aqueous buffer) and/or modify the ink viscosity, for example. Because such high-boiling organic solvents are already present in many ink compositions (e.g., aqueous ink compositions), an as-produced polymeric dispersant dissolved or dispersed in the high-boiling organic solvent may be used to directly formulate an ink composition without isolating the polymeric dispersant from the high-boiling organic solvent. Instead, the high-boiling organic solvent associated with the polymeric dispersant from the polymer synthesis may replace or supplement the high-boiling solvent being used to formulate the ink composition. Amounts of the high-boiling organic solvent in the ink compositions may be the same as, more than, or less than those conventionally present. Thus, the present disclosure leverages the discovery that high-boiling organic solvents conventionally used in ink compositions may also effectively promote formation of polymeric dispersants suitable for formulating the ink compositions. Surprisingly, potential polymerization reaction byproducts retained in the high-boiling organic solvent do not significantly compromise the properties of the resulting ink composition formed therefrom.

Advantageously, formulating ink compositions in the foregoing manner eliminates the issues associated with solvent removal from the polymeric dispersant. Moreover, formulating the ink composition in the foregoing manner does not introduce additional solvents beyond those that are already used to form the ink composition. Furthermore, high-boiling organic solvents may lower the surface tension of the ink composition, consequently enhancing colorant wetting and grindability.

In addition to the benefits that may be realized when forming ink compositions in accordance with the foregoing, use of a high-boiling organic solvent during the process of forming a polymeric dispersant may afford further advantages as well. At the least, the high-boiling organic solvent may allow higher polymerization temperatures to be used relative to those attainable with low-boiling organic solvents. The higher reaction temperatures may allow the polymerization reaction to be completed in a shorter time, while simultaneously reducing polymer composition drift, particularly for monomers with varying reactivity or having capability of undergoing degradation during extended reaction times. Moreover, because solvent removal is no longer needed during the polymerization process, an overall time of the polymerization process (cycle time) may be decreased.

Accordingly, ink compositions of the present disclosure may comprise: a continuous phase comprising water and one or more high-boiling organic solvents having a boiling point of about 145° C. or more (e.g., about 145° C. to about 400° C.); a polymeric dispersant dissolved or dispersed as solids in the continuous phase; and one or more colorants dispersed as solids in the continuous phase. The continuous phase may contain about 5 wt % or less, or about 10 wt % or less organic solvents having a boiling point of about 140° C. or less, based on total mass of the ink compositions. Preferably, the polymeric dispersant may be at least partially dissolved, more preferably fully dissolved, in the continuous phase.

In some examples, the continuous phase may contain about 10 wt % or less, or about 8 wt % or less, or about 6 wt % or less, or about 4 wt % or less, or about 3 wt % or less, or about 2 wt % or less, or about 1 wt % or less, or about 0.5 wt % or less, or about 0.1 wt % or less organic solvents having a boiling point of about 140° C. or less (low-boiling organic solvents). Preferably, the continuous phase may be free of (lack) or substantially free of low-boiling organic solvents. The continuous phase may be considered substantially free of low-boiling organic solvents when a non-zero amount up to about 0.1 wt % low-boiling organic solvent is present. The foregoing values are based upon a total mass of the ink composition.

The ink compositions of the present disclosure may comprise any amount of high-boiling organic solvent sufficient to dissolve or disperse the polymeric dispersant in the continuous phase. In non-limiting examples, the high-boiling organic solvent may be present in the ink compositions in an amount ranging from about 1 wt % to about 60 wt %, based upon a total mass of the ink composition, such as about 10 wt % to about 30 wt %, or about 25 wt % to about 55 wt %, or about 30 wt % to about 60 wt %, or about 40 wt % to about 60 wt %, or about 50 wt % to about 60 wt %, each based upon total mass of the ink compositions.

The ink compositions may be formulated using polymer dispersions prepared in the presence of one or more high-boiling organic solvents and in the absence or substantial absence of low-boiling organic solvents. The polymer dispersions may comprise: one or more high-boiling organic solvents having a boiling point of about 145° C. to about 400° C. or a sub-range thereof; and a polymeric dispersant dissolved or dispersed as solids in the one or more high-boiling organic solvents. The polymer dispersions may contain about 5 wt % or less, or about 10 wt % or less organic solvents having a boiling point of about 140° C. or less, based on total mass of the polymer dispersions. Preferably, the polymer dispersions may be free or substantially free of organic solvents having a boiling point of about 140° C. or less. The polymer dispersions may contribute any fraction of the high-boiling organic solvent(s) that are present in the ink compositions described herein. In non-limiting examples, the polymer dispersions may contribute about 10 wt % to 100 wt % of the high-boiling organic solvent(s) that are present in the ink compositions described herein.

The polymer dispersions of the present disclosure may contain about 10 wt % or less, or about 8 wt % or less, or about 6 wt % or less, or about 4 wt % or less, or about 3 wt % or less, or about 2 wt % or less, or about 1 wt % or less, or about 0.5 wt % or less, or about 0.1 wt % or less low-boiling organic solvents. Preferably, the polymer dispersions may be free of (lack) or substantially free of low-boiling organic solvents. The polymer dispersions may be considered substantially free of low-boiling organic solvents when a non-zero amount up to about 0.1 wt % low-boiling organic solvent is present. The foregoing values are based upon a total mass of the polymer dispersions.

The polymeric dispersants present in the ink compositions and polymer dispersions herein are not believed to be particularly limited, provided that the polymeric dispersant may be adequately synthesized in a high-boiling organic solvent, as described herein, and the polymeric dispersant may, in turn, adequately disperse one or more colorants, such as one or more pigments, in an ink composition.

The polymeric dispersant may be a vinyl polymer having additional functionality suitable to facilitate dissolution or dispersion thereof in an aqueous-based continuous phase. The additional functionality may comprise a carboxylic acid or sulfonic acid, for example. In one or more examples, the polymeric dispersant may comprise an acrylate polymer or copolymer. The term “acrylate” equivalently refers to polymers derived from acrylic acid or methacrylic acid, esters thereof, or copolymers thereof. Suitable acrylate polymers may be prepared by free radical polymerization of one or more acrylate monomers, for example.

Acrylate monomers that may be present in the polymeric dispersants include, but are not limited to, acrylic acid, methacrylic acid, acrylate esters, methacrylate esters, methyl acrylate or methacrylate, ethyl acrylate or methacrylate, 2-ethylhexyl acrylate or methacrylate, cycloalkyl acrylates or methacrylates, such as isobornyl acrylate or methacrylate and cyclohexyl acrylate or methacrylate, benzyl acrylate or methacrylate, and fatty alcohol acrylates or methacrylates, such as those containing capryl, capric, lauryl, myristyl, cetyl, or stearyl alcohol as the alcohol component of the ester.

The polymeric dispersant may comprise a copolymer of acrylic or methacrylic acid and one or more additional acrylate monomers. In some examples, a suitable acrylate copolymer for use in the disclosure herein may comprise a copolymer of benzyl methacrylate, stearyl methacrylate, methacrylic acid, and poly(ethylene glycol) methyl ether methacrylate.

Suitable high-boiling organic solvents for use in the inks and polymer dispersions described herein are not believed to be particularly limited, provided that the high-boiling organic solvent is at least partially water soluble, is effective to promote at least partial dissolution of the polymeric dispersant, and may be used to conduct polymerization. Illustrative high-boiling organic solvents may include, but are not limited to, C₅₊ monohydric alcohols, C₂₊ glycols or polyols, C₂₊ glycol or polyol monoethers or monoesters, C₂₊ amides, cyclic carbonates, dimethylsulfoxide, tetramethylene sulfone, or any combination thereof. As used herein, the term “glycol” refers to an organic molecule containing two or more alcohol groups, which may be vicinal (located on adjacent carbon atoms) or non-vicinal (located on non-adjacent carbon atoms). As used herein, the term “polyol” refers to an organic molecule containing three or more alcohol groups, which may be located upon adjacent and/or non-adjacent carbon atoms.

In some or other non-limiting examples, suitable high-boiling organic solvents may include, but are not limited to, cyclohexanol, furfuryl alcohol, tetrahydrofurfuryl alcohol, ethylene glycol, diethylene glycol, propylene glycol, 1,2-butanediol, 1,3-butanediol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, 2-methyl-2,4-pentanediol, hexanetriol, thiodiglycol, tetraethylene glycol, 3-methoxy-1-butanol, 2-butoxyethanol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, propylene glycol monopropyl ether, propylene glycol monobutyl ether, dipropylene glycol, dipropylene glycol monomethyl ether, dipropylene glycol monoethyl ether, dipropylene glycol monopropyl ether, tripropylene glycol methyl ether, ethylene glycol diacetate, ethylene glycol monomethyl ether acetate, ethylene glycol monobutyl ether acetate, diethylene glycol monoethyl ether acetate, ethylene carbonate, propylene carbonate, diacetone alcohol, 1-methyl-4-piperidone, cyrene, pentanamide, N-methylbutanamide, butylformamide, N,N-dimethylacetamide, N,N-diethylacetamide, pyrrolidone, N-methyl-2-pyrrolidone, N-propyl-pyrrolidone, N-butyl-pyrrolidone, N-vinyl-2-pyrrolidone, oxazolidone, piperidinone, N-ethyl-valerolactam, N-propyl-valerolactam, N-butyl-valerolactam, caprolactam, N-ethyl-caprolactam, N-propyl-caprolactam, dimethyl sulfoxide, tetramethylene sulfone, or any combination thereof. In more specific examples, the ink compositions and polymer dispersions described herein may comprise one or more high-boiling organic solvents such as, for example, propylene glycol, 1,2-butanediol, 1,2-hexanediol, 3-methoxy-1-butanol, diethylene glycol monomethyl ether, or any combination thereof.

In addition to high-boiling organic solvents originating from the polymer dispersion, the ink compositions may contain other high-boiling organic solvents originating from other sources such as, for example, ethylene glycol, diethylene glycols, glycerine, dipropylene glycols, polyethylene glycols, polypropylene glycols, trimethylolpropane, 1,5-pentanediol, 2-methyl-1,3-propanediol, 2-ethyl-2-hydroxymethyl-1,3-propanediol, 3-methoxybutanol, 3-methyl-1,5-pentanediol, 1,3-propanediol, 1,4-butanediol, 2,4-heptanediol, amides, ethers, urea, substituted ureas such as thiourea, ethylene urea, alkylurea, alkylthiourea, dialkylurea, and dialkylthiourea, carboxylic acids and their salts, such as 2-methylpentanoic acid, 2-ethyl-3-propylacrylic acid, 2-ethylhexanoic acid, 3-ethoxyproponic, acid, esters, organosulfides, organosulfoxides, sulfones (such as sulfolane), carbitol, butyl carbitol, ethers, tripropylene glycol monomethyl ether, ether derivatives, hydroxyethers, amino alcohols, ketones, N-methylpyrrolidinone, 2-pyrrolidinone, cyclohexylpyrrolidone, amides, sulfoxides, lactones, polyelectrolytes, methyl sulfanylethanol imidazole, 1,3-dimethyl-2-imdazolidinone, substituted and unsubstituted formamides, substituted and unsubstituted acetamides, the like, or any combination thereof. Any of the foregoing may be utilized alone or in combination with propylene glycol, 1,2-butanediol, 1,2-hexanediol, 3-methoxy-1-butanol, diethylene glycol monomethyl ether or the other high-boiling organic solvents listed above. Some of the foregoing may also be suitable for conducting a polymerization reaction to form a polymeric dispersant as well.

In one or more examples, the ink compositions and polymer dispersions described herein may be free of (lack) or substantially free of low-boiling organic solvents such as, for example, isopropanol, methyl ethyl ketone, butyl acetate, butanol, toluene, xylenes, propylene glycol monomethyl ether, or any combination thereof.

Colorants within the ink compositions may comprise one or more pigments, which may be organic and/or inorganic in nature. The pigments may be dispersed as solids (i.e., in the form of particulates) within the ink compositions. Suitable pigments may include a black pigment, a white pigment, a cyan pigment, a magenta pigment, a yellow pigment, and any combination thereof. More specific examples of suitable pigments follow below.

Pigments may be included in the ink compositions in an effective amount to provide a desired coloration to the ink composition or a surface printed therewith. In addition, the effective amount of pigment may be chosen to facilitate sufficient dispersion of the pigment by the polymeric dispersant. In non-limiting examples, the pigment may be included in the ink compositions in an amount of about 0.05 wt % to about 15 wt %, or about 0.1 wt % to about 10 wt %, or about 2 wt % to about 7 wt %, or about 1 wt % to about 5 wt %, based on a total mass of the ink composition.

The pigment and the polymeric dispersant may be present in the ink compositions over a wide composition range. In non-limiting examples, a mass ratio of pigment to polymeric dispersant may range from about 20:1 to about 1:1, or about 10:1 to about 1:1, or about 8:1 to about 1:1, or about 6:1 to about 1:1, or about 5:1 to about 1:1.

The pigments may be dispersed as solids (i.e., as particulates) within the ink compositions. Suitable particle sizes for the pigment within the ink compositions may include an average diameter (D50, volume-weighted mean diameter) of about 20 nm to about 500 nm, or about 20 nm to about 400 nm, or about 30 nm to about 300 nm. Particle sizes may be determined by a dynamic light scattering particle size analyzer, such as a Malvern Mastersizer instrument or a Nanotrac Flex instrument. Suitable pigment particles may be spherical or non-spherical in shape.

Suitable inorganic pigments may include, for example, carbon black, iron black, manganese dioxide, titanium oxide, zinc white, zinc sulfide, antimony white, ultramarine, Persian blue, cobalt blue (CoO—Al₂O₃), cerulean blue, cerium uranium blue, Egyptian blue, Han blue, azurite, basic copper carbonate, Prussian blue, manganese blue, chrome yellow (PbCrO₄), orpiment, Primrose yellow, cobalt yellow, strontium yellow, titanium yellow, stannic sulfide, zinc yellow, cerium sulfide red, and iron oxide.

Suitable organic pigments may include, for example, azo pigments including diazo pigments and monoazo pigments, polycyclic pigments (e.g., phthalocyanine pigments such as phthalocyanine blues and phthalocyanine greens), perylene pigments, perinone pigments, anthraquinone pigments, quinacridone pigments, dioxazine pigments, thioindigo pigments, isoindolinone pigments, pyranthrone pigments, and quinophthalone pigments), insoluble dye chelates (e.g., basic dye type chelates and acidic dye type chelate), nitro pigments, nitroso pigments, anthanthrone pigments such as PR168, and the like, Illustrative phthalocyanine blues and greens may include copper phthalocyanine blue, copper phthalocyanine green, and derivatives thereof (Pigment Blue 15, Pigment Green 7, and Pigment Green 36). Illustrative quinacridones may include Pigment Orange 48, Pigment Orange 49, Pigment Red 122, Pigment Red 192, Pigment Red 202, Pigment Red 206, Pigment Red 207, Pigment Red 209, Pigment Violet 19, and Pigment Violet 42. Illustrative anthraquinones may include Pigment Red 43, Pigment Red 194, Pigment Red 177, Pigment Red 216 and Pigment Red 226. Illustrative perylenes may include Pigment Red 123, Pigment Red 149, Pigment Red 179, Pigment Red 190, Pigment Red 189 and Pigment Red 224, Illustrative thioindigoids may include Pigment Red 86, Pigment Red 87, Pigment Red 88. Pigment Red 181. Pigment R ed 198, Pigment Violet 36, and Pigment Violet 38. Illustrative heterocyclic yellows may include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 90, Pigment Yellow 110, Pigment Yellow 117, Pigment Yellow 120, Pigment Yellow 128, Pigment Yellow 138, Pigment Yellow 150, Pigment Yellow 151, Pigment Yellow 155, and Pigment Yellow 213.

Examples of black pigments that may be used include carbon pigments. Suitable carbon pigments may include, for example, carbon black, graphite, vitreous carbon, charcoal, and combinations thereof. Such carbon pigments can be manufactured by a variety of known methods, such as a channel method, a contact method, a furnace method, an acetylene method, or a thermal method, and are commercially available from such vendors as Cabot Corporation, Columbian Chemicals Company, Evonik, and E.I. DuPont de Nemours and Company.

The ink compositions disclosed herein may include additional components as well. For example, the ink compositions may further comprise one or more surfactants, which may further aid in dissolution of the polymeric dispersant. Examples of suitable surfactants may include anionic surfactants, cationic surfactants, nonionic surfactants, zwitterionic surfactants, and any combination thereof. When included, the surfactant may be included in an amount of about 0.01 wt % to about 10 wt %, or about 0.02 wt % to about 5 wt %, based on total mass of the ink composition.

Examples of suitable surfactants may include, but are not limited to, alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethlene oxide amides, dimethicone copolyols, substituted amine oxides, and the like, with specific examples including primary, secondary, and tertiary amine salt compounds such as hydrochloric acid salts, acetic acid salts of laurylamine, coconut amine, stearylamine, and rosin amine; quaternary ammonium salt type compounds such as lauryltrimethylammonium chloride, cetyltrimethylamnmonium chloride, benzyltributylammonium chloride, benzalkonium chloride, and the like; pyridinium salt type compounds such as cetylpyridinium chloride, cetylpyridinium bromide, and the like; nonionic surfactants such as polyoxyethylene alkyl ethers, polyoxyethylene alkyl esters, acetylene alcohols, acetylene glycols, and the like; and other surfactants such as 2-heptadecenyl-hydroxyethylimidazoline, dihydroxyethystearylamine, stearyldimethylbetaine, and lauryldihydroxyethylbetaine; fluorosurfactants; and the like, as well as mixtures thereof. Additional examples of suitable surfactants may include polyacrylic acid, methalose, methyl cellulose, ethyl cellulose, propyl cellulose, hydroxyethyl cellulose, carboxymethyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, block copolymers of polyethylene oxide and polypropylene oxide, sodium dodecylsulfate (SDS), sodium dodecylbenzene sulfonate, sodium dodecylnaphthalene sulfate, dialkyl benzenealkyl sulfates and sulfonates, acids such as abietic acid, alkyldiphenyloxide disulfonates, branched sodium dodecyl benzene sulfonates, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂-C₁₇ trimethylammonium bromides, halide salts of quaternized polyoxyethylalkylamines, dodecylbenzyl triethylammonium chloride, and any combination thereof.

The ink compositions may further comprise crosslinkers. Examples of suitable crosslinkers may include, for instance, an organoamine, a dihydroxy aromatic compound, an isocyanate, a peroxide, a metal oxide, an epoxide, a carbodimide, the like, and any combination thereof. When conducted, crosslinking may further enhance the physical properties of images generated from the ink composition. When a crosslinker is utilized, the crosslinker may be present in an effective amount such as, for example, about 0.1 wt % to about 20 wt %, or about 5 wt % to about 15 wt %, based on total mass of the ink composition.

In addition, the ink compositions may further comprise additional additives as well. Optional additives that can be included in the ink compositions include biocides, fungicides. pH controlling agents such as acids or bases, phosphate salts, carboxylates salts, sulfite salts, amine salts, buffers, chelating agents such as EDTA (ethylenediamine tetraacetic acid), viscosity modifiers, leveling agents, the like, and any combination thereof. When included, one having ordinary skill in the art will be able to select suitable additives and amounts thereof.

In view of the foregoing, the present disclosure further includes methods for forming ink compositions. Methods for forming ink compositions according to the present disclosure may comprise: obtaining a polymer dispersion comprising a polymeric dispersant that is dissolved or dispersed as solids in one or more high-boiling organic solvents having a boiling point of about 145° C. to about 400° C., in which the polymer dispersion contains about 10 wt % or less organic solvents having a boiling point of about 140° C. or less; combining the polymer dispersion with an aqueous carrier fluid (e.g., water or a mixture of water and an organic solvent, optionally containing one or more organic or inorganic additives) without removing at least a portion of the high-boiling organic solvent to form a continuous phase in which the polymeric dispersant is dissolved or dispersed as solids in the continuous phase; and combining one or more colorants and, optionally, one or more additives with the continuous phase containing the polymeric dispersant to form an ink composition comprising the one or more colorants dispersed as solids in the continuous phase.

Combining the one or more colorants, such as one or more pigments, with the polymer dispersion may comprise one or more of stirring, grinding, sonicating, or like agitation techniques. Optionally, the polymer dispersion may be heated in the course of combining the one or more colorants with the polymer dispersion.

Forming the ink composition may take place concurrently with combining the one or more colorants with the continuous phase, or formation of the ink composition may take place after the one or more colorants and the continuous phase have been at least partially combined. If the continuous phase already contains all the components needed to produce a finished ink, combining and forming may take place concurrently. Otherwise, combining the one or more colorants with the continuous phase may take place to form an intermediate composition, with one or more further additives being introduced afterward to complete the formation of a finished ink composition.

Optionally, obtaining the polymer dispersion may take place by forming the polymer dispersion according to the description herein. In brief, the polymer dispersion may be formed by polymerization of one or more monomers in the presence of one or more high-boiling organic solvents, which are then allowed to remain in the polymer dispersion for subsequent introduction to the aqueous carrier fluid to form the ink composition. Alternately, the polymer dispersion may be obtained from a stock solution and/or purchased from a commercial source.

Ink compositions of the present disclosure may be applied to a substrate in an imagewise pattern. Alternately, the ink compositions described herein may be applied to a substrate as an overcoat or a portion of an overcoat.

The ink compositions may be applied to a substrate using inkjet printing. Suitable inkjet printing processes will be familiar to persons having ordinary skill in the art and may include any of thermal inkjet processes, acoustic inkjet processes, piezoelectric inkjet processes, or any combination thereof.

Embodiments disclosed herein include the following:
A. Ink compositions. The ink compositions comprise: a continuous phase comprising water and one or more high-boiling organic solvents having a boiling point of about 145° C. to about 400° C.; a polymeric dispersant dispersed as solids or dissolved in the continuous phase; and one or more colorants dispersed as solids in the continuous phase; wherein the continuous phase contains about 10 wt % or less organic solvents having a boiling point of about 140° C. or less.
B. Polymer dispersions for forming an ink composition. The polymer dispersion comprise one or more high-boiling organic solvents having a boiling point of about 145° C. to about 400° C.; and a polymeric dispersant dissolved or dispersed as solids in the one or more high-boiling organic solvents; wherein the polymer dispersion contains about 10 wt % or less organic solvents having a boiling point of about 140° C. or less.
C. Methods for forming an ink composition. The methods comprise: obtaining a polymer dispersion comprising a polymeric dispersant that is dissolved or dispersed as solids in one or more high-boiling organic solvents having a boiling point of about 145° C. to about 400° C.; wherein the polymer dispersion contains about 10 wt % or less organic solvents having a boiling point of about 140° C. or less; combining the polymer dispersion with an aqueous carrier fluid without removing at least a portion of the high-boiling organic solvent to form a continuous phase; wherein the polymeric dispersant is dissolved or dispersed as solids in the continuous phase; and combining one or more colorants and, optionally, one or more additives with the continuous phase containing the polymeric dispersant to form an ink composition comprising the one or more colorants dispersed as solids in the continuous phase.

Each of embodiments A-C may include one or more of the following elements in any combination.
Element 1: wherein the one or more high-boiling organic solvents comprise at least one solvent selected from the group consisting of a C₅₊ monohydric alcohol, a C₂₊ glycol or polyol, a C₂₊ glycol or polyol monoether or monoester, a C₂₊ amide, a cyclic carbonate, dimethylsulfoxide, tetramethylsulfone, and any combination thereof.
Element 2: wherein the one or more high-boiling organic solvents comprise a solvent selected from the group consisting of cyclohexanol, furfuryl alcohol, tetrahydrofurfuryl alcohol, ethylene glycol, diethylene glycol, propylene glycol, 1,2-butanediol, 1,3-butanediol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, 2-methyl-2,4-pentanediol, hexanetriol, thiodiglycol, tetraethylene glycol, 3-methoxy-1-butanol, 2-butoxyethanol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, propylene glycol monopropyl ether, propylene glycol monobutyl ether, dipropylene glycol, dipropylene glycol monomethyl ether, dipropylene glycol monoethyl ether, dipropylene glycol monopropyl ether, tripropylene glycol methyl ether, ethylene glycol diacetate, ethylene glycol monomethyl ether acetate, ethylene glycol monobutyl ether acetate, diethylene glycol monoethyl ether acetate, ethylene carbonate, propylene carbonate, diacetone alcohol, 1-methyl-4-piperidone, cyrene, pentanamide, N-methylbutanamide, butylformamide, N,N-dimethylacetamide, N,N-diethylacetamide, pyrrolidone, N-methyl-2-pyrrolidone, N-propyl-pyrrolidone, N-butyl-pyrrolidone, N-vinyl-2-pyrrolidone, oxazolidone, piperidinone, N-ethyl-valerolactam, N-propyl-valerolactam, N-butyl-valerolactam, caprolactam, N-ethyl-caprolactam, N-propyl-caprolactam, dimethyl sulfoxide, tetramethylene sulfone, and any combination thereof.
Element 3: wherein the continuous phase is substantially free of organic solvents having a boiling point of about 140° C. or less.
Element 3A: wherein the polymer dispersion is substantially free of organic solvents having a boiling point of about 140° C. or less.
Element 3B: wherein the ink composition is substantially free of organic solvents having a boiling point of about 140° C. or less.
Element 4: wherein the continuous phase is substantially free of isopropanol, methyl ethyl ketone, butanol, butyl acetate, toluene, xylene, propylene glycol monomethyl ether, and any combination thereof.
Element 5: wherein the polymeric dispersant comprises an acrylate polymer or copolymer.
Element 6: wherein the one or more colorants comprise one or more pigments.
Element 7: wherein the one or more pigments have a D50 ranging from about 20 nm to about 500 nm.
Element 8: wherein the one or more pigments comprise about 0.1 wt % to about 15 wt % of the ink composition, based on a total mass of the ink composition.
Element 9: wherein the polymeric dispersant comprises about 0.1 wt % to about 40 wt % of the ink composition, based on a total mass of the ink composition.
Element 10: wherein the polymeric dispersant is dissolved in the one or more high-boiling organic solvents.

By way of non-limiting example, illustrative combinations applicable to A-C include, but are not limited to, 1 or 2, and 3, 3A, 3B, or 4; 1 or 2, and 5; 1 or 2, and 6; 1 or 2, and 6 and 7; 1 or 2, and 6-8; 1 or 2, and 6 and 8; 1 or 2, and 6, 8, and 9; 1 or 2, 9 and 10; 1 or 2, and 10; 1 or 2, and 3, 3A, 3B, or 4, and 5; 1 or 2, and 3, 3A, 3B, or 4, and 6; 1 or 2, and 3, 3A, 3B, or 4, and 6 and 7; 1 or 2, and 3, 3A, 3B, or 4, and 6-8; 1 or 2, and 3, 3A, 3B, or 4, and 6, 8, and 9; 1 or 2, and 3, 3A, 3B, or 4, and 6 and 8; 1 or 2, and 3, 3A, 3B, or 4, and 9 and 10; 1 or 2, and 3, 3A, 3B, or 4, and 10; 3, 3A, 3B, or 4, and 5; 3, 3A, 3B, or 4, and 6; 3, 3A, 3B, or 4, and 6 and 7; 3, 3A, 3B, or 4, and 6-8; 3, 3A, 3B, or 4, and 6 and 8; 3, 3A, 3B, or 4, and 6, 8, and 9; 3, 3A, 3B, or 4, and 9 and 10; 3, 3A, 3B, or 4, and 10; 6 and 7; 6 and 8; 6-8; 6, 7, and 9; 6-9; 6, 8, and 9; 6 and 10; 6, 7, and 10; 6-8, and 10; 6-10; and 9 and 10.

To facilitate a better understanding of the present disclosure, the following examples of preferred or representative embodiments are given. In no way should the following examples be read to limit, or to define, the scope of the invention.

### EXAMPLES

Example 1. Comparative Polymer Dispersion. In a 1 L flask, 486 g of isopropanol (b.p.=82° C.) was purged with N₂ and heated at 80° C. A monomer solution containing 105 g of benzyl methacrylate, 76 g of stearyl methacrylate, 81 g of methacrylic acid, 3 g of dodecyl mercaptan (chain transfer agent for molecular weight control), 16 g of poly(ethylene glycol) methyl ether methacrylate (50 wt % in water, 8 g active monomer), 7 g of 2,2′-azobis(2-methylpropionitrile) radical initiator, and 200 g of isopropanol was added to the flask at a rate of 4 g/min with stirring. After addition of the monomer solution was complete, the reaction mixture was held at 80° C. for 7 hours. Thereafter, 112 g of methyl diethanolamine was added to the resulting polymer solution. Subsequently, the isopropanol was removed under vacuum (˜3-4 hours) to recover the polymeric dispersant largely free of the organic solvent (at least trace amounts of organic solvent remain). Deionized water was added during solvent removal to reduce viscosity and prevent precipitation of the polymeric dispersant. After the isopropanol had been removed, sufficient deionized water was introduced to adjust the dispersed solid content of the polymeric dispersant to ˜20 wt %.

Example 2. Experimental Polymer Dispersion. In a 1 L flask, 250 g of diethylene glycol monoethyl ether (DGME, b.p.=196° C.) was purged with N₂ and heated at 90° C. A monomer solution containing 105 g of benzyl methacrylate, 76 g of stearyl methacrylate, 81 g of methacrylic acid, 16 g of poly(ethylene glycol) methyl ether methacrylate (50 wt % in water, 8 g active monomer), 9 g of 2,2′-azobis(2-methylpropionitrile) radical initiator, and 250 g of DGME was added to the flask at a rate of 6 g/min under stirring. After addition of the monomer solution was complete, the reaction mixture was maintained at 90° C. for ˜4 hours. Thereafter, 112 g of methyl diethanolamine was added to the resulting polymer solution, and sufficient deionized water was added to adjust the dissolved solid content of the polymeric dispersant to ˜20 wt %.

Example 3. Experimental Polymer Dispersion. The polymer dispersion of this example was prepared in the same manner as Example 2, except 7 g of 2,2′-azobis(2-methylpropionitrile) radical initiator was used.

Table 1 summarizes selected molecular weight properties for the polymeric dispersants resulting from Examples 1-3. Molecular weight values of the polymeric dispersants were determined by gel permeation chromatography (GPC) and correlated against polystyrene standards.

TABLE 1

| | | Mn | Mw | Mw/Mn |
|---|---|---|---|---|
| Entry | Sample | (g/mol) | (g/mol) | (PDI) |
| 1 | Example 1 | 8721 | 14970 | 1.72 |
| | (Comparative) | | | |
| 2 | Example 2 | 8433 | 14738 | 1.75 |
| | (Experimental) | | | |
| 3 | Example 2, | 8468 | 14399 | 1.70 |
| | repeat | | | |
| | (Experimental) | | | |
| 4 | Example 3 | 11714 | 21516 | 1.84 |
| | (Experimental) | | | |

Comparing Entries 1-3, the polymer synthesis in DGME was repeatable to produce the polymeric dispersant with consistent molecular weight properties, as well as molecular weight properties consistent with the polymeric dispersant formed in isopropanol. Thus, essentially the same polymeric dispersant may be produced with both a ˜40% reduction in polymerization time and a ˜60% reduction in total cycle time, all while eliminating low-boiling organic solvents from the polymer solution and the ink composition resulting therefrom (see below). Moreover, the synthesis conditions in DGME may be changed to alter the molecular weight properties of the polymeric dispersant, if needed (Entry 4).

Ink Compositions. The polymeric dispersions of Example 1 (isopropanol synthesis) and Example 2 (DGME synthesis) were combined with Pigment Red 184 (specific surface area of ˜44 m²/g) at a pigment:polymeric dispersant ratio of 5:1 and milled against YTZ zirconia media for 3 hours using a Hockmeyer media mill. The resulting pigment dispersions were then formulated into a finished ink having a composition as specified in Table 2. The particle size distribution of the pigment dispersions and the corresponding finished inks were then evaluated using a Nanotrac Flex particle size analyzer. Table 3 shows the pigment particle sizes in the pigment dispersions and in the corresponding finished inks.

TABLE 2

| | Wt % based on total |
|---|---|
| Component | composition |
| Pigment dispersion | 5 |
| 1,2-Propandiol | 25 |
| Diethylene glycol monoethyl ether | 3 |
| Glycerol | 5 |
| SURFYNOL 104E | 0.1 |
| (tetramethyldecynediol, Evonik) | |
| SURFYNOL 465 | 0.5 |
| (ethoxylated acetylenic diol, Evonik) | |
| Bactericide | 0.1 |
| Deionized water | balance |

TABLE 3

| | D₅₀ |
|---|---|
| Sample | (nm) |
| Example 1, polymer dispersion | ~206 |
| with pigment | |
| Example 1, finished ink | ~193 |
| Example 2, polymer dispersion | ~203 |
| with pigment | |
| Example 2, finished ink | ~193 |

As shown, the presence of DGME in the polymer dispersion and in the finished ink (Example 2 samples) did not appreciably alter the particle size of the pigment, relative to the comparative polymeric dispersion and finished ink (Example 1 samples). Thus, the comparative polymeric dispersant and the resulting finished ink (Example 1 samples) may contain trace amounts of residual low-boiling organic solvent from the polymer synthesis. In contrast, by utilizing at least one in-common high-boiling organic solvent for the polymer synthesis and the finished ink (Example 2 samples), trace amounts of residual low-boiling organic solvents may be avoided while still obtaining dispersed pigment particles of similar size.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is the following:

1. An ink composition comprising:
a continuous phase comprising water and one or more high-boiling organic solvents having a boiling point of about 145° C. to about 400° C.;
a polymeric dispersant dispersed as solids or dissolved in the continuous phase; and
one or more colorants dispersed as solids in the continuous phase;
wherein the continuous phase contains about 10 wt % or less organic solvents having a boiling point of about 140° C. or less.

2. The ink composition of claim 1, wherein the one or more high-boiling organic solvents comprise at least one solvent selected from the group consisting of a C₅₊ monohydric alcohol, a C₂₊ glycol or polyol, a C₂₊ glycol or polyol monoether or monoester, a C₂₊ amide, a cyclic carbonate, dimethylsulfoxide, tetramethylsulfone, and any combination thereof.

3. The ink composition of claim 1, wherein the one or more high-boiling organic solvents comprise a solvent selected from the group consisting of cyclohexanol, furfuryl alcohol, tetrahydrofurfuryl alcohol, ethylene glycol, diethylene glycol, propylene glycol, 1,2-butanediol, 1,3-butanediol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, 2-methyl-2,4-pentanediol, hexanetriol, thiodiglycol, tetraethylene glycol, 3-methoxy-1-butanol, 2-butoxyethanol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, propylene glycol monopropyl ether, propylene glycol monobutyl ether, dipropylene glycol, dipropylene glycol monomethyl ether, dipropylene glycol monoethyl ether, dipropylene glycol monopropyl ether, tripropylene glycol methyl ether, ethylene glycol diacetate, ethylene glycol monomethyl ether acetate, ethylene glycol monobutyl ether acetate, diethylene glycol monoethyl ether acetate, ethylene carbonate, propylene carbonate, diacetone alcohol, 1-methyl-4-piperidone, cyrene, pentanamide, N-methylbutanamide, butylformamide, N,N-dimethylacetamide, N,N-diethylacetamide, pyrrolidone, N-methyl-2-pyrrolidone, N-propyl-pyrrolidone, N-butyl-pyrrolidone, N-vinyl-2-pyrrolidone, oxazolidone, piperidinone, N-ethyl-valerolactam, N-propyl-valerolactam, N-butyl-valerolactam, caprolactam, N-ethyl-caprolactam, N-propyl-caprolactam, dimethyl sulfoxide, tetramethylene sulfone, and any combination thereof.

4. The ink composition of claim 1, wherein the continuous phase is substantially free of organic solvents having a boiling point of about 140° C. or less.

5. The ink composition of claim 1, wherein the polymeric dispersant comprises an acrylate polymer or copolymer.

6. The ink composition of claim 1, wherein the one or more colorants comprise one or more pigments.

7. The ink composition of claim 6, wherein the one or more pigments comprise about 0.1 wt % to about 15 wt % of the ink composition, based on a total mass of the ink composition.

8. The ink composition of claim 1, wherein the polymeric dispersant comprises about 0.1 wt % to about 40 wt % of the ink composition, based on a total mass of the ink composition.

9. A polymer dispersion comprising:
one or more high-boiling organic solvents having a boiling point of about 145° C. to about 400° C.; and
a polymeric dispersant dissolved or dispersed as solids in the one or more high-boiling organic solvents;
wherein the polymer dispersion contains about 10 wt % or less organic solvents having a boiling point of about 140° C. or less.

10. The polymer dispersion of claim 9, wherein the one or more high-boiling organic solvents comprise a solvent selected from the group consisting of cyclohexanol, furfuryl alcohol, tetrahydrofurfuryl alcohol, ethylene glycol, diethylene glycol, propylene glycol, 1,2-butanediol, 1,3-butanediol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, 2-methyl-2,4-pentanediol, hexanetriol, thiodiglycol, tetraethylene glycol, 3-methoxy-1-butanol, 2-butoxyethanol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, propylene glycol monopropyl ether, propylene glycol monobutyl ether, dipropylene glycol, dipropylene glycol monomethyl ether, dipropylene glycol monoethyl ether, dipropylene glycol monopropyl ether, tripropylene glycol methyl ether, ethylene glycol diacetate, ethylene glycol monomethyl ether acetate, ethylene glycol monobutyl ether acetate, diethylene glycol monoethyl ether acetate, ethylene carbonate, propylene carbonate, diacetone alcohol, 1-methyl-4-piperidone, cyrene, pentanamide, N-methylbutanamide, butylformamide, N,N-dimethylacetamide, N,N-diethylacetamide, pyrrolidone, N-methyl-2-pyrrolidone, N-propyl-pyrrolidone, N-butyl-pyrrolidone, N-vinyl-2-pyrrolidone, oxazolidone, piperidinone, N-ethyl-valerolactam, N-propyl-valerolactam, N-butyl-valerolactam, caprolactam, N-ethyl-caprolactam, N-propyl-caprolactam, dimethyl sulfoxide, tetramethylene sulfone, and any combination thereof.

11. The polymer dispersion of claim 9, wherein the polymer dispersion is substantially free of organic solvents having a boiling point of about 140° C. or less.

12. The polymer dispersion of claim 9, wherein the polymeric dispersant comprises an acrylate polymer or copolymer.

13. A method for preparing an ink composition, comprising:
obtaining a polymer dispersion comprising a polymeric dispersant that is dissolved or dispersed as solids in one or more high-boiling organic solvents having a boiling point of about 145° C. to about 400° C.;
wherein the polymer dispersion contains about 10 wt % or less organic solvents having a boiling point of about 140° C. or less;
combining the polymer dispersion with an aqueous carrier fluid without removing at least a portion of the high-boiling organic solvent to form a continuous phase;
wherein the polymeric dispersant is dissolved or dispersed as solids in the continuous phase; and
combining one or more colorants and, optionally, one or more additives with the continuous phase containing the polymeric dispersant to form an ink composition comprising the one or more colorants dispersed as solids in the continuous phase.

14. The method of claim 13, wherein the one or more high-boiling organic solvents comprise at least one solvent selected from the group consisting of a C₅₊ monohydric alcohol, a C₂₊ glycol or polyol, a C₂₊ glycol or polyol monoether or monoester, a C₂₊ amide, a cyclic carbonate, dimethylsulfoxide, tetramethylsulfone, and any combination thereof.

15. The method of claim 13, wherein the one or more high-boiling organic solvents comprise a solvent selected from the group consisting of cyclohexanol, furfuryl alcohol, tetrahydrofurfuryl alcohol, ethylene glycol, diethylene glycol, propylene glycol, 1,2-butanediol, 1,3-butanediol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, 2-methyl-2,4-pentanediol, hexanetriol, thiodiglycol, tetraethylene glycol, 3-methoxy-1-butanol, 2-butoxyethanol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, propylene glycol monopropyl ether, propylene glycol monobutyl ether, dipropylene glycol, dipropylene glycol monomethyl ether, dipropylene glycol monoethyl ether, dipropylene glycol monopropyl ether, tripropylene glycol methyl ether, ethylene glycol diacetate, ethylene glycol monomethyl ether acetate, ethylene glycol monobutyl ether acetate, diethylene glycol monoethyl ether acetate, ethylene carbonate, propylene carbonate, diacetone alcohol, 1-methyl-4-piperidone, cyrene, pentanamide, N-methylbutanamide, butylformamide, N,N-dimethylacetamide, N,N-diethylacetamide, pyrrolidone, N-methyl-2-pyrrolidone, N-propyl-pyrrolidone, N-butyl-pyrrolidone, N-vinyl-2-pyrrolidone, oxazolidone, piperidinone, N-ethyl-valerolactam, N-propyl-valerolactam, N-butyl-valerolactam, caprolactam, N-ethyl-caprolactam, N-propyl-caprolactam, dimethyl sulfoxide, tetramethylene sulfone, and any combination thereof.

16. The method of claim 13, wherein the ink composition is substantially free of organic solvents having a boiling point of about 140° C. or less.

17. The method of claim 13, wherein the polymeric dispersant comprises an acrylate polymer or copolymer.

18. The method of claim 13, wherein the one or more colorants comprise one or more pigments.

19. The method of claim 18, wherein the one or more pigments comprise about 0.1 wt % to about 15 wt % of the ink composition, based on a total mass of the ink composition.

20. The method of claim 13, wherein the polymeric dispersant comprises about 0.1 wt % to about 40 wt % of the ink composition, based on a total mass of the ink composition.
